(19) United States
(12) Patent Application Publication
(10) Pub. No.: US 2015/0146684 A1
(43) Pub. Date: May 28, 2015

(54) UPLINK TRANSMISSION POWER AND TIMING ADJUSTMENT IN TD-SCDMA BATON HANDOVER

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/090,551

(22) Filed: Nov. 26, 2013

(51) Int. Cl. H04W 36/00

(52) U.S. Cl. CPC H04W 36/0005
USPC 370/331

(57) ABSTRACT

A user equipment (UE) may adjust its uplink transmission power and timing for communications with a target cell while awaiting completion of a baton handover procedure. The amount of adjustments for the uplink transmission power/timing may be based on an amount of time remaining before baton handover failure is declared. The steps size of the adjustments may increase as the time remaining before handover failure becomes smaller.

### BACKGROUND

1. Field

Aspects of the present disclosure relate generally to wireless communication systems, and more particularly, to uplink transmission power and timing adjustment during baton handover in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method of wireless communication. The method includes tuning uplink communications to a target cell as part of a baton handover. The method also includes adjusting uplink transmission power or timing by a user equipment while waiting for the baton handover to complete. The adjusting may occur prior to receipt of a transmit power control command.

Offered is an apparatus for wireless communication. The apparatus includes means for tuning uplink communications to a target cell as part of a baton handover. The apparatus also includes means for adjusting uplink transmission power or timing by a user equipment while waiting for the baton handover to complete. The adjusting may occur prior to receipt of a transmit power control command.

Offered is a computer program product for wireless communication in a wireless network. The computer program product includes a non-transitory computer-readable medium having program code recorded thereon. The program code includes program code to tune uplink communications to a target cell as part of a baton handover. The program code also includes program code to adjust uplink transmission power or timing by a user equipment while waiting for the baton handover to complete. The adjusting may occur prior to receipt of a transmit power control command.

Offered is an apparatus for wireless communication. The apparatus includes a memory and at least one processor coupled to the memory. The processor(s) is configured to tune uplink communications to a target cell as part of a baton handover. The processor(s) is also configured to adjust uplink transmission power or timing by a user equipment while waiting for the baton handover to complete. The adjusting may occur prior to receipt of a transmit power control command.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates an example of network coverage areas.

FIG. 5 illustrates a call flow for baton handover according to one aspect of the present disclosure.

FIG. 6 illustrates a method for improved baton handover according to one aspect of the present disclosure.

FIG. 7 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

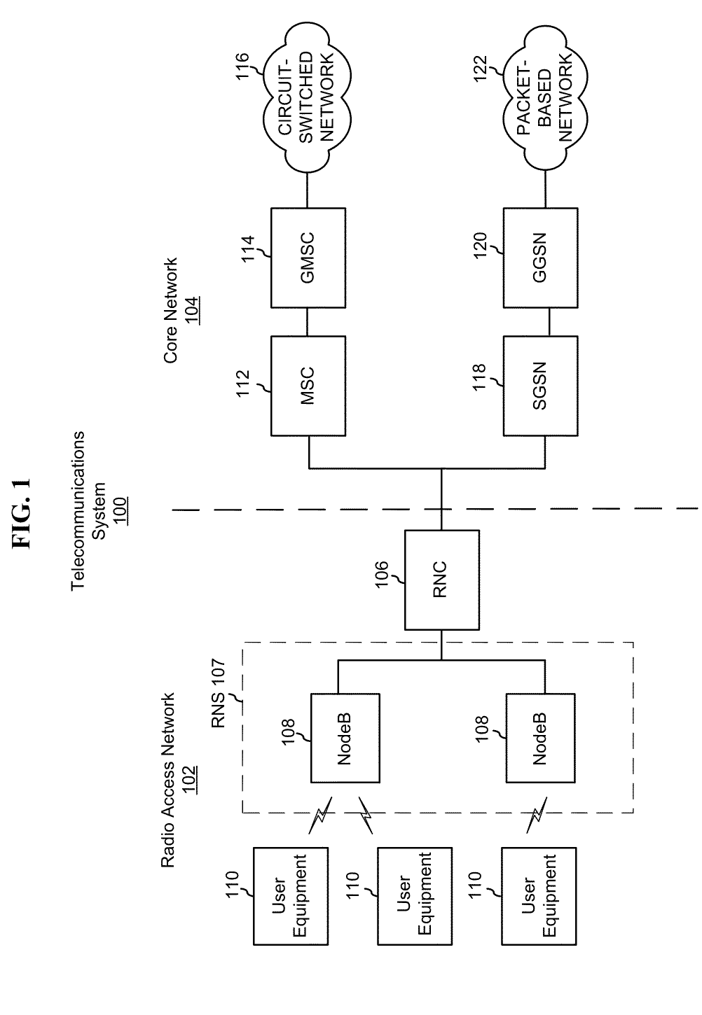

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

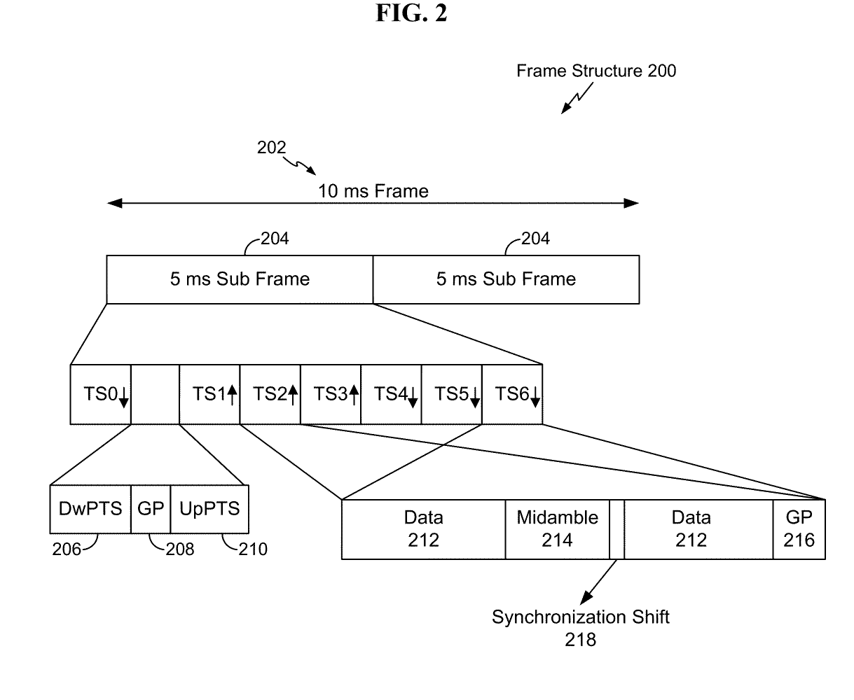

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

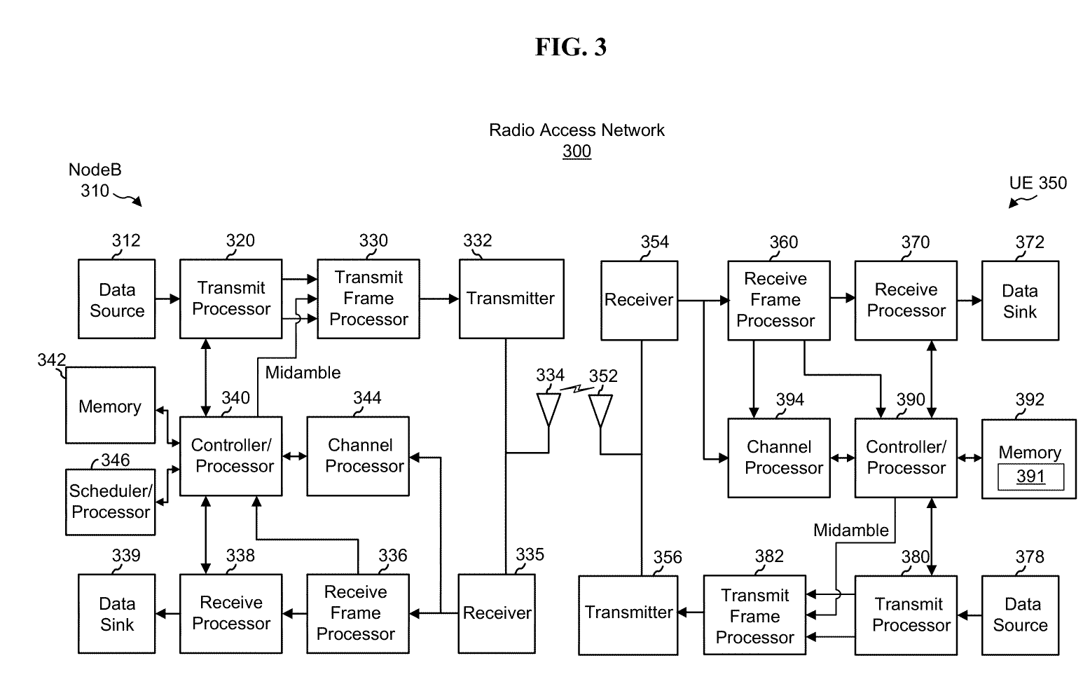

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a baton handover module 391 which, when executed by the controller/processor 390, configures the UE 350 to, during baton handover, to adjust uplink transmission power and timing. A scheduler/processor 346 at the node B 310 may be used to allocate resources to the UEs and schedule downlink and/or uplink transmissions for the UEs.

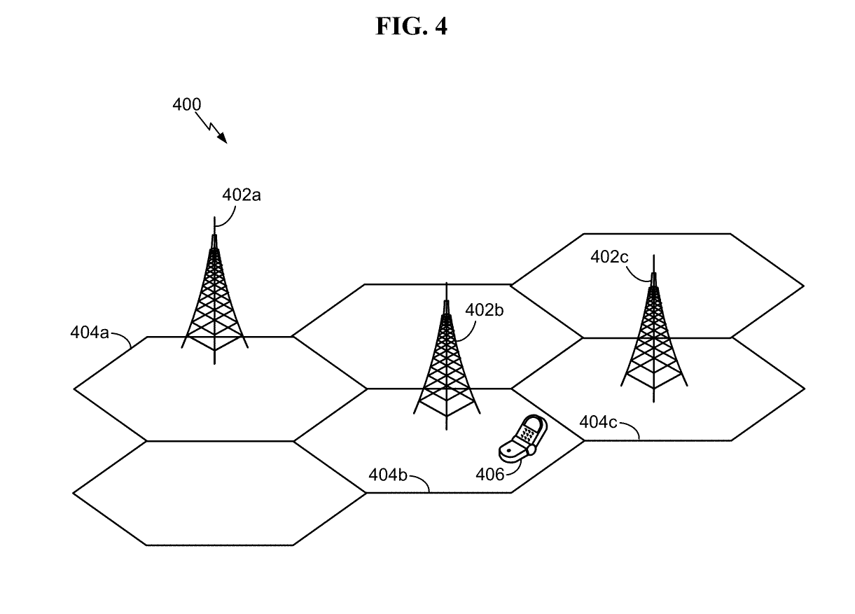

Some base stations in a network may cover only a portion of a geographical area. FIG. 4 illustrates coverage of a network, such as a TD-SCDMA network, as represented by individual base stations. A geographical area 400 may include multiple TD-SCDMA base stations, illustrated by towers 402a, 402b, and 402c, each serving their own respective geographic locations, illustrated by geographic cells 404a, 404b, and 404c, respectively. A user equipment (UE) 406 may move from one cell, such as cell 404a, to another cell, such as a cell 404b. The movement of the UE 406 may specify a handover or a cell reselection.

Baton Handover with Receive Diversity in TD-SCDMA

One feature of a Time Division-Synchronous Code Division Multiple Access (TD-SCDMA) network is the baton handover, which is widely deployed in certain networks. For a baton handover, upon receiving the handover command from the source node B, the UE first switches its uplink (UL) communications from the source node B to the target node B. The UE also sends the target node B a special burst which can help the target node B acquire the uplink and build downlink (DL) beamforming based on the uplink measurements. The DL beamforming will assist the communications from the target node B to the UE. Once UL communications have been handed over, then the UE switches its DL communications to the target node B.

During the transition period between UL handover and DL handover, the UE receives downlink communications from the source cell and sends uplink communications to the target cell. To manage this transition period, a handover timer begins upon handover of the UL communications. As presently indicated in the TD-SCDMA specification, this handover timer (also called the fixed downlink baton handover uplink to downlink switch timer) is 80 ms long. After this handover timer expires, the UE switches the downlink communications to the target cell. Per certain specifications, during the transition period the network sends downlink data to both the source and target cell after sending the handover command to the UE. As the handover command may take some time to reach the UE, sending data for the UE to both the source and target node Bs makes it more likely that the data makes its way to the UE regardless of where the UE is in its handover procedure. After the network receives the indication that the handover procedure to the target cell is complete, the network proceeds to only send downlink data for the UE to the target cell. If, however, the network receives a handover failure indication from the source cell, the network proceeds to only send downlink data for the UE to the source cell as the UE never completed the handover procedure and has, for purposes of the network reverted to the source cell.

TD-SCDMA handover trigger is based on a primary frequency Primary Common Control Physical Channel (PCCPCH) received signal code power (RSCP) measurement of source and the target cell. The PCCPCH RSCP is mainly determined by path loss, i.e., the distance between the node B and the UE. During the handover transition, without closed loop power control and timing control to adapt to radio frequency (RF) variations, a data package may be lost during transition. If a UE attempts handover to a target frequency with poor performance, handover failure and/or call drop may result.

During the transition period, a UE cannot perform closed link power control as its downlink communications are still with the source cell but its uplink communications have been transitioned to the target cell. A UE determines its initial uplink transmit (Tx) power on the Dedicated Physical Channel (P_{DPCHTx}) to the target cell based on a network signaled desired power for the Dedicated Physical Channel (P_{DPCHdes}) and the measured path loss of the signal from the target cell. The path loss may be calculated by the UE as the RSCP of the PCCPCH (noted as RSCP_{PCCPCH}) minus the transmitted power of the target cell PCCPCH (noted as P_{PCCPCHTx}). Thus the UE uplink transmit power may be calculated as P_{DPCHTx}=P_{DPCHdes}+(RSCP_{PCCPCH}−P_{PCCPCHTx}) where RSCP_{PCCPCH} is measured by the UE and both P_{DPCHdes} and P_{PCCPCHTx} are sent to the UE from the target cell.

Due to the open loop nature of these calculations and other problems, in certain circumstances the transmit power calculated by the UE as described above is inaccurate, resulting in uplink communications that are insufficient for the target cell to detect the UE. Without the uplink communications from the UE, the target cell may not be able to properly determine the beamforming for downlink communications to the UE, and may not configure downlink transmissions to the UE. This in turn leads to the UE being unable to detect the downlink in-sync indication from the target cell within the allotted handover time indicated by the network, resulting in baton handover failure.

Offered is a technique to enhance power control to improve baton handover. After a UE calculates its initial uplink transmit power level, the UE determines how much time is left before the handover timer expires. The UE may then increase its transmit power level while waiting for the baton handover to complete. The UE may increase its transmit power based on the amount of time left before the handover timer expires. The handover timer activates and begins counting after the UE receives the physical channel reconfiguration message from the radio network controller. Based on the amount of time left, the UE may continue to increase its transmit power until baton handover completes or the timer expires. Thus, if the time already expired reaches x % of the total handover timer, the UE may increase its P_{DPCHTx} by y %. For example, the UE may increase its transmit power by 3 dB if 50% of the timer has expired, 6 dB if 75% of the timer has expired, etc. These increases in power and time expired levels may be configured (even dynamically) as desired to improve UE performance and reduce baton handover failure. Further, the increases in transmit power may grow as more and more of the timer expires. Thus, as the timer approaches expiration, the UE may continue to increase the transmit power more aggressively to avoid handover failure.

In one aspect the UE may adjust its transmit power autonomously, that is without receiving a transmit power control message from the target cell. Once the UE receives the downlink in-sync message, or a transmit power control message from the target cell, the UE may adjust its transmit power to a level indicated by the target cell.

In addition to improving power control, baton handover timing control may also be improved. During baton handover a UE determines its initial uplink transmission timing to the target cell based on a measured downlink timing difference between the source cell and target cell. This may be referred to as open loop pre-sync timing. The difference between the downlink source and target cell timing may be referred to as the observed timing difference (OTD). The OTD may be of different types, depending on the network specification. For example, type 1 OTD may be based on a timing difference between the PCCPCHs of the cells. Type 2 OTD may be based on a timing difference between the CPICHs (Common Pilot Channel) of the cells. Thus, the UE may determine its new timing adjustment (TA) for uplink communications with the target cell (TA_{new}) based on the UE's old timing adjustment for uplink communications with the source cell (TA_{old}) plus the observed downlink timing difference. Thus TA_{new}=TA_{old}+OTD. This open loop pre-sync timing may result in inaccuracies and potential handover failure.

A node B's monitoring time window for uplink communications from a particular UE (such as for the uplink DPCH or special burst) may be smaller than the monitoring time window for the UpPCH preamble. If the UE's calculated timing adjustment for uplink communications with the target cell is incorrect, the UE uplink transmissions may go undetected by the target cell, thus resulting in no downlink transmissions to the UE, further resulting in the UE not detecting the downlink in-sync indication from the target cell before the handover timer expires, and finally resulting in baton handover failure.

Offered is a technique to enhance timing adjustments to improve baton handover. After a UE calculates its initial timing advance, the UE determines how much time is left before the handover timer expires. The UE may then adjust its timing advance while waiting for the baton handover to complete. The UE may increase its timing advance adjustment based on the amount of time left before the handover timer expires.

Thus, if the time already expired reaches x % of the total handover timer, the UE may advance or delay its uplink transmission timing by y chips from its initial uplink transmission timing. These adjustments to timing may be configured (even dynamically) as desired to improve UE performance and reduce baton handover failure. Further, the adjustment size to the timing may grow as more and more of the timer expires. The UE may also adjust the amount of advance or delay in the timing adjustment based on the amount of time remaining for example adjusting the timing by y chips upon reaching 50% of the handover timer, by 2*y upon reaching 75% of the handover timer, etc. Thus, as the timer approaches expiration, the UE may continue to adjust its uplink timing to try to catch the appropriate node B monitoring window and avoid handover failure. The UE may alternate advancing (i.e., adjusting timing forward) or delaying (i.e., adjusting timing backward) the timing adjustment to account for different potential desired timings.

The size of the power adjustment and/or timing adjustment discussed above may also be determined as a function of path loss. Further, after each adjustment of power and/or timing, the UE may wait for a certain period of time to determine if a downlink in-sync is received, or the UE has any other indication of the success or failure of the power/timing adjustment. This time period may account for time for UL/DL communications to travel back and forth from the UE as well as time for the node B to adjust its beamforming and other processing to prepare communicatinos with the UE. After the period of time expires, the UE may then may further adjustments to power/timing to complete the connection with the target cell.

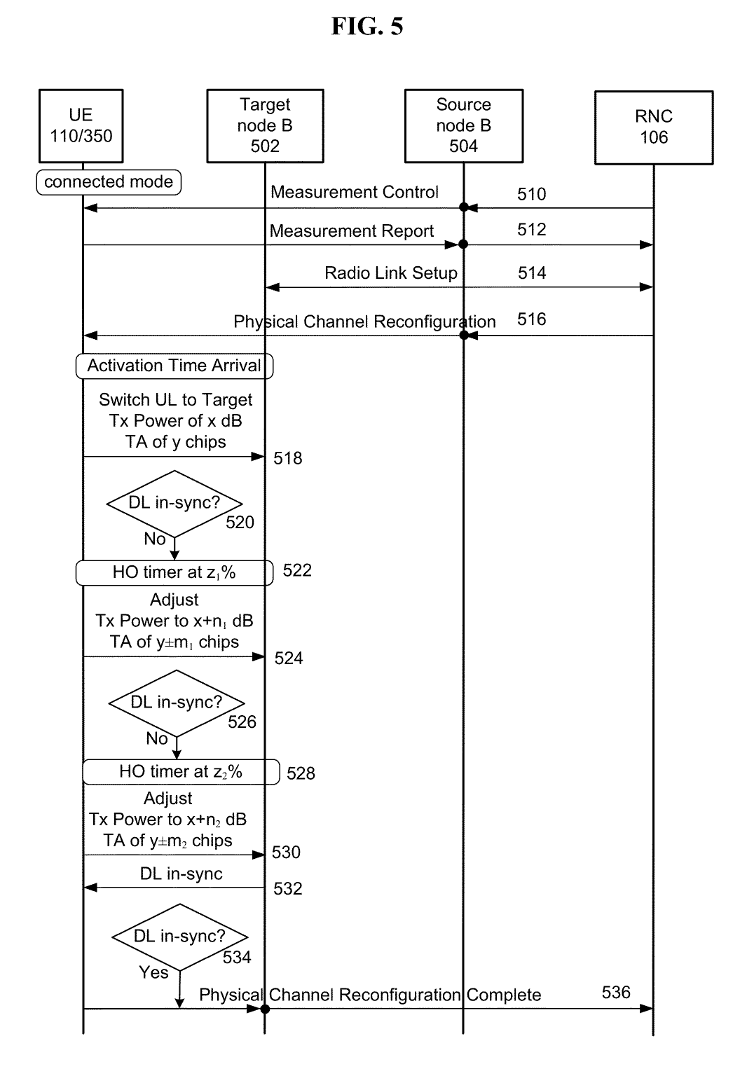

FIG. 5 illustrates a call-flow according to one aspect of the present disclosure. The UE 350 begins the call in connected mode with the source node B 504. During the call the RNC 106 initiates a measurement control message 510 to be sent to the UE 350 through the source node B 504. In response to the measurement control message 510, the UE measures neighboring potential target cells and reports those measurements in a measurement report 512 to the source node B which is sent to the RNC 106. Based on the measurements obtained by the UE, the RNC then determines that target node B 502 should be the target cell for the UE during handover The RNC and target node B 502 then perform a radio link setup exchange 514. The RNC then initiates a physical channel reconfiguration (i.e., handover) message 516 to be sent to the UE through the source node B 504. The physical channel reconfiguration message includes the identity of the target node B as well as the activation time.

Upon arrival of the activation time, the UE 350 commences baton handover. The UE 350 switches its UL to connect to the target node B 502, as indicated in line 518. The UE 350 chooses an initial transmit power of x dB and an initial timing adjustment of y chips. These initial values may be set according to the equations discussed above.

The UE then waits a period of time to determine (520) if a downlink (DL) in-sync indication has been received from the target node B 502. If no DL in-sync message has been received the UE checks the remaining time in the handover (HO) timer. As illustrated, at time 522 the HO timer is at z₁ %. The UE then adjusts its Tx power to x+n₁ dB and adjusts its timing adjustment (TA) to y±m₁ chips. The values of n₁ and m₁ may be based on z₁. The UE then transmits (524) to the target node B 502 using the adjusted power and TA values.

The UE then again waits a period of time to determine (526) if a downlink (DL) in-sync indication has been received from the target node B 502. If no DL in-sync message has been received the UE again checks the remaining time in the handover (HO) timer. As illustrated, at time 526 the HO timer is at z₂%. The UE then adjusts its Tx power to x+n₂ dB and adjusts its timing adjustment (TA) to y±m₂ chips. The values of n₂ and m₂ may be based on z₂. The UE then transmits (530) to the target node B 502 using the adjusted power and TA values.

As illustrated, the UE then receives the DL in-sync message from the node B at time 532. The next time the UE checks for the DL in-sync message (534), the UE may note that the message has been received and will complete baton handover through a physical channel reconfiguration complete message at time 536.

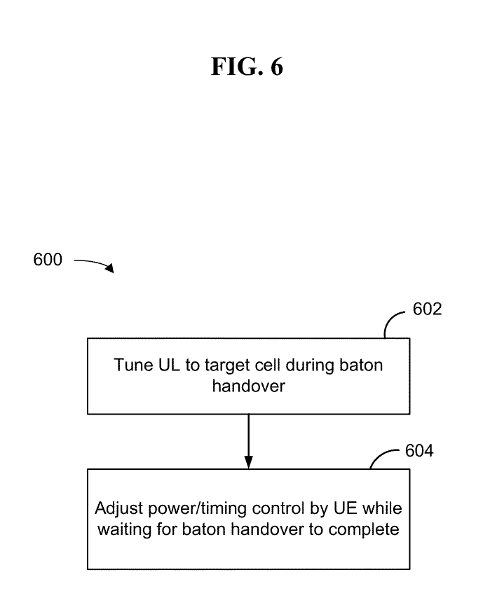

FIG. 6 shows an example of a wireless communication method 600 that may be used by the controller/processor 390 of the UE 110/350 during baton handover. A UE tunes uplink communications to a target cell as part of a baton handover, as shown in block 602. The UE also adjusts power control or timing by a user equipment while waiting for the baton handover to complete, as shown in block 604. The adjusting may take place without the UE having received a transmit power control command.

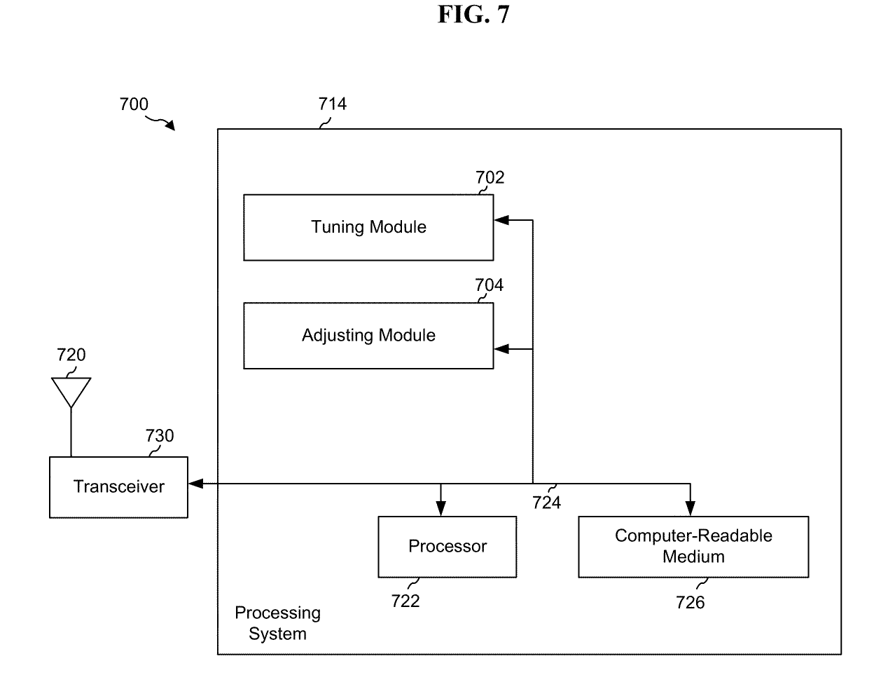

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the modules 702 and 704, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a tuning module 702 for tuning uplink communications to a target cell as part of a baton handover. The processing system 714 includes an adjusting module 704 for adjusting power control or timing by a user equipment while waiting for the baton handover to complete. The adjusting may occur by the UE without the UE having received a transmit power control command. The modules may be software modules running in the processor 722, resident/stored in the computer readable medium 726, one or more hardware modules coupled to the processor 722, or some combination thereof. The processing system 614 may be a component of the UE 110 and may include the memory 392, and/or the controller/processor 390.

In one configuration, an apparatus such as a UE 110/350 is configured for wireless communication including means for tuning. In one aspect, the tuning means may be the antennas 352/720, the transmitter 356, the transmit processor 380, the transmit frame processor 282, the controller/processor 390, the memory 392, baton handover module 391, tuning module 702, and/or the processing system 714 configured to perform the receiving means.

The UE is also configured to include means for adjusting a transmit power/timing adjustment. In one aspect, the adjusting means may be the antennas 352/720, the transmitter 356, the transmit processor 380, the transmit frame processor 282, the controller/processor 390, the memory 392, baton handover module 391, adjusting module 704 and/or the processing system 714 configured to perform the means. In one aspect the means functions recited by the aforementioned means. In another aspect, the aforementioned means may be a module or any apparatus configured to perform the functions recited by the aforementioned means.

Several aspects of a telecommunications system has been presented with reference to 3GPP in general, and to TD-SCDMA in particular. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
tuning uplink communications to a target cell as part of a baton handover; and
adjusting uplink transmission power or timing by a user equipment, prior to receipt of a transmit power control command, while waiting for the baton handover to complete.

2. The method of claim 1, in which adjusting the uplink transmission power comprises increasing the uplink transmission power based at least in part on how much time remains before handover failure will be declared.

3. The method of claim 2, in which an amount of adjustment increases as a function of an amount of time remaining before handover failure will be declared.

4. The method of claim 1, in which adjusting the timing comprises either advancing uplink transmission timing or delaying the uplink transmission timing based on a current uplink transmission timing.

5. The method of claim 4, in which an amount of adjustment increases as a function of an amount of time remaining before handover failure will be declared.

6. The method of claim 4, in which the current uplink transmission timing is an initial uplink transmission timing plus an adjustment and the initial uplink transmission timing is an uplink transmission timing with a source cell plus a measured downlink time difference between the source cell and the target cell.

7. The method of claim 1, in which a size of adjustment of the uplink transmission power or timing is a function of path loss.

8. The method of claim 1, further comprising validating the adjusting during a time period, the time period being a function of an amount time it takes for a network to detect uplink transmission and start downlink transmission and for a UE to detect a downlink transmission.

9. An apparatus for wireless communication, comprising:
means for tuning uplink communications to a target cell as part of a baton handover;
and
means for adjusting uplink transmission power or timing by a user equipment, prior to receipt of a transmit power control command, while waiting for the baton handover to complete.

10. The apparatus of claim 9, in which the means for adjusting the uplink transmission power comprises means for increasing the uplink transmission power based at least in part on how much time remains before handover failure will be declared.

11. A computer program product for wireless communication in a wireless network, comprising:
a non-transitory computer-readable medium having program code recorded thereon, the program code comprising:
program code to tune uplink communications to a target cell as part of a baton handover; and
program code to adjust uplink transmission power or timing by a user equipment, prior to receipt of a transmit power control command, while waiting for the baton handover to complete.

12. The computer program product of claim 11, in which the program code to adjust the uplink transmission power comprises program code to increase the uplink transmission power based at least in part on how much time remains before handover failure will be declared.

13. An apparatus for wireless communication, comprising:
a memory; and
at least one processor coupled to the memory and configured:
to tune uplink communications to a target cell as part of a baton handover; and
to adjust uplink transmission power or timing by a user equipment, prior to receipt of a transmit power control command, while waiting for the baton handover to complete.

14. The apparatus of claim 13, in which the at least one processor is configured to adjust the power by increasing the uplink transmission power based at least in part on how much time remains before handover failure will be declared.

15. The apparatus of claim 14, in which an amount of adjustment increases as a function of an amount of time remaining before handover failure will be declared.

16. The apparatus of claim 13, in which the at least one processor is configured to adjust the timing by either advancing uplink transmission timing or delaying the uplink transmission timing based on a current uplink transmission timing.

17. The apparatus of claim 16, in which an amount of adjustment increases as a function of an amount of time remaining before handover failure will be declared.

18. The apparatus of claim 16, in which the current uplink transmission timing is an initial uplink transmission timing plus an adjustment and the initial uplink transmission timing is an uplink transmission timing with a source cell plus a measured downlink time difference between the source cell and the target cell.

19. The apparatus of claim 13, in which a size of adjustment of the uplink transmission power or timing is a function of path loss.

20. The apparatus of claim 13, in which the at least one processor is further configured to validate the adjusting during a time period, the time period being a function of an amount time it takes for a network to detect uplink transmission and start downlink transmission and for a UE to detect a downlink transmission.
